(19) United States
(12) Patent Application Publication
(10) Pub. No.: US 2008/0304128 A1
(43) Pub. Date: Dec. 11, 2008

(54) Speckle Reduction by Angular Scanning for Laser Projection Displays

(75) Inventors: Matthias Busker, Viersen (DE); Oscar Hendrikus Willemsen, Den Bosch (NL); Marcellinus Petrus Carolus Michael Krijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,966

(22) PCT Filed: Dec. 13, 2006
(86) PCT No.: PCT/IB2006/054822

§ 371 Date: Jun. 18, 2008

Related U.S. Application Data
(60) Provisional application No. 60/751,533, filed on Dec. 19, 2005.
(60) Provisional application No. 60/863,001, filed on Oct. 26, 2006.

(51) Int. Cl. G02B 27/48

(52) U.S. Cl. 359/246

(57) ABSTRACT

The present invention provides a system (200) (300) (700) (800) and method for the reduction of speckle by applying a moving mirror (202) in the light engine of a projector. By imaging the mirror surface onto the entrance face of a multimode wave-guide (204), the beam enters the wave-guide (204) at a time-varying angle. When this wave-guide (204) is used to illuminate a display panel, the projected image on the wall has a time-varying speckle pattern. Since the period of the mirror is well below the integration time of the eye, a reduced speckle intensity is perceived. The use of the wave-guide (204) further reduces the speckle intensity due to mode scrambling.

The present invention relates to reduction of the visibility of laser speckle. More particularly, the present invention provides a system, apparatus and method for reduction of the visibility of laser speckle by modulating the angle under which an image is projected onto a screen without blurring the image.

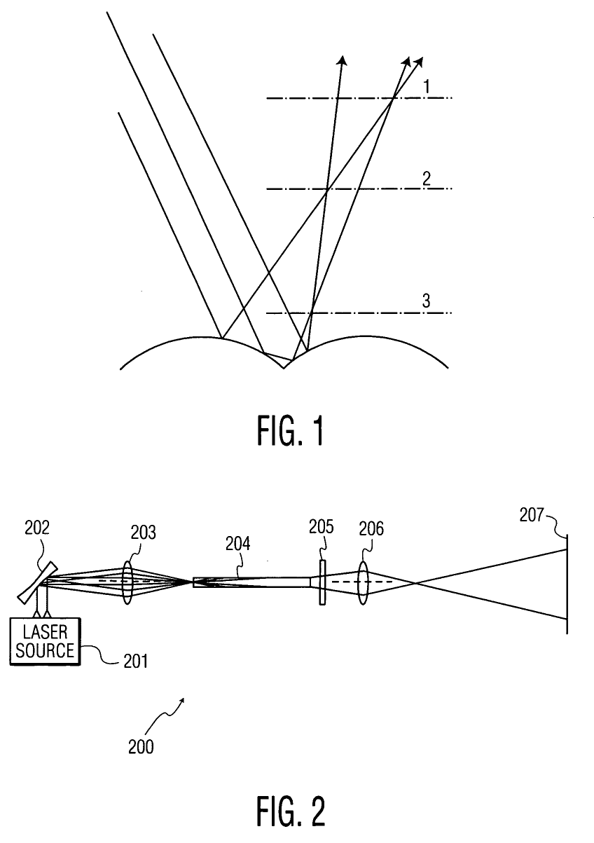

One of the most challenging problems in the realization of laser projection displays is the decrease of image resolution due to so-called speckle. Speckle appears if more or less coherent light is scattered by a rough surface (see FIG. 1). The surface is causing a path difference between the individual rays, which results in an imprinted phase difference. If these rays recombine, the imprinted phase difference will lead to interference (whether the rays interfere constructively or destructively just depends on the phase difference). If an observer is looking at a laser-illuminated screen, the scattered laser light will produce an interference pattern on the retina, which depends on the surface structure of the screen and the optical parameters of the human eye, such as the diameter of the iris and the status of the eye's lens (focal length and distance between the lens and the retina). The observer will notice bright and dim regions, which will change if the spatial position of the eye is being changed. The spots will get smaller or bigger if the observers head is moved forward or backward, respectively. A slow lateral movement of the eye can result in a very fast movement of the speckle pattern. This speckle effect makes an unperturbed vision of a laser-projected image impossible.

There are, in general, two ways to reduce the appearance of speckle.

The first way is to reduce the spatial or temporal coherence of the laser beam, which is determined by the so-called coherence length. The coherence length is defined as the path length after which two individual rays lose their distinct phase relation and are not able to interfere anymore. If one could reduce the coherence length of a laser beam below the surface roughness of a screen structure, the rays would not interfere on the observer's retina. This effect would totally de-speckle a laser image. As a laser source is using stimulated emission for the generation of light, laser light has a very high coherence length. For comparison: White sun light has a coherence length of approximately 1 μm, the emission of a laser diode is in the range of 500 μm to 1 mm and highly stabilized gas lasers can have a coherence length of some hundred meters. Hence, it is difficult to reduce the coherence of laser irradiation to a level at which interference does not occur. A sufficient reduction of spatial or temporal coherence can be attained by several methods. One can, for example, use moving diffusers to produce a random phase difference, a large number of optical fibers to produce a path difference or mode scrambling, which occurs in highly multi-moded optical wave-guides.

The second way to reduce speckle is to use the natural integration time of the eye. The human eye integrates about 50 ms on one image. If one could change the speckle pattern at a frequency higher than 20 Hz, the eye would integrate several slightly different speckle patterns, which would reduce the speckle contrast. A simple way to reach this goal is to vibrate the screen.

For a (mobile) laser projection display, the speckle reduction mechanism should be light weight, small, and inexpensive. Furthermore it should contain few mechanical parts, have a low power consumption and de-speckle the projected image so that it is not perceived by an observer. One can easily realize that most of the mechanisms, which reduce the coherence of the laser beam, do not meet these practical boundary conditions. The speckle reduction setups using moving diffusers, for example, comprise many optical components and make use of complex moving mechanical elements. This produces a large, heavy, expensive and non-robust setup. On the other hand, using a bundle of fibers of different fiber lengths would result in a rather large setup, a lower level of speckle reduction and a loss of light because of high damping and insertion losses.

When considering a vibrating screen, to make use of the integration of the human eye, a complex mechanical setup for large screens is needed and furthermore the need of a dedicated screen cannot be met by a mobile projection system.

The present invention provides a system, apparatus and method for reduction of the visibility of laser speckle by modulating the angle under which an image is projected onto a screen without blurring the image.

A first preferred embodiment of a setup comprises a collimated laser beam comprising an emitting laser source that is scanned by an oscillating mirror, a lens imaging the mirror surface to an image plane where the image is stationary, an entrance facet of a multimode wave-guide placed in the image plane in order to have a good coupling to the wave-guide, a homogenized light output from the wave-guide passing through a 2D light modulation panel and a projection lens imaging the light modulation panel onto a screen.

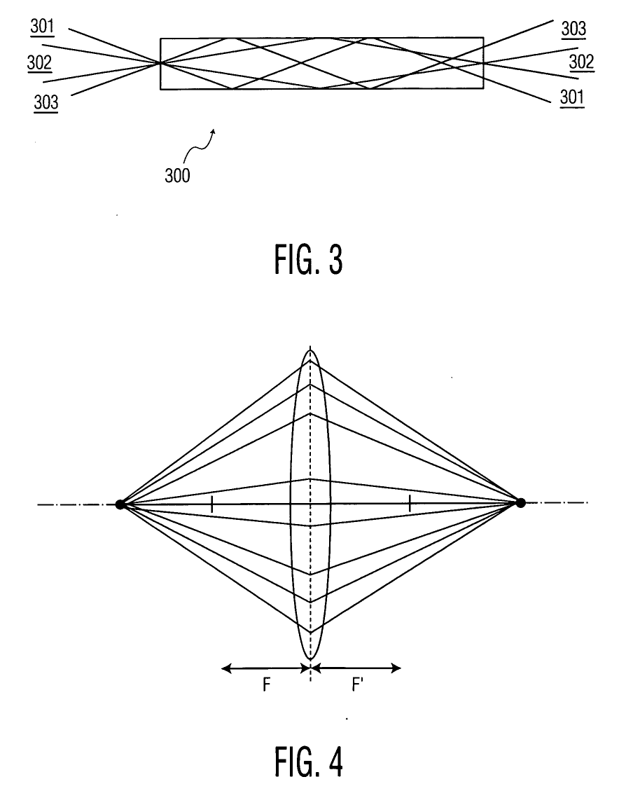

As illustrated in FIG. 3 imaging the laser beam onto a fiber entrance facet represents a straightforward coupling to the wave-guide, coupling 301 and 303 under critical angles of total internal reflection, scanning 301 to 303 in a sinusoidal manner such that, due to multiple reflections within the wave-guide and different transition velocities for separate modes, the beam path is folded and thus the device works as a normal homogenizer, in which separate rays of the laser beam scan a wave-guide end facet.

In the first embodiment, the setup comprises a mirror having a scanning angle of incidence with an oscillation frequency such that each ray, coming from one object point, is imaged to one image point wherein when the scanning angle of incidence (between the ray and the lens 203) changes, the refractive power of the lens 203 changes (as a function of distance to the lens axis and one stable image plane is produced as a result.

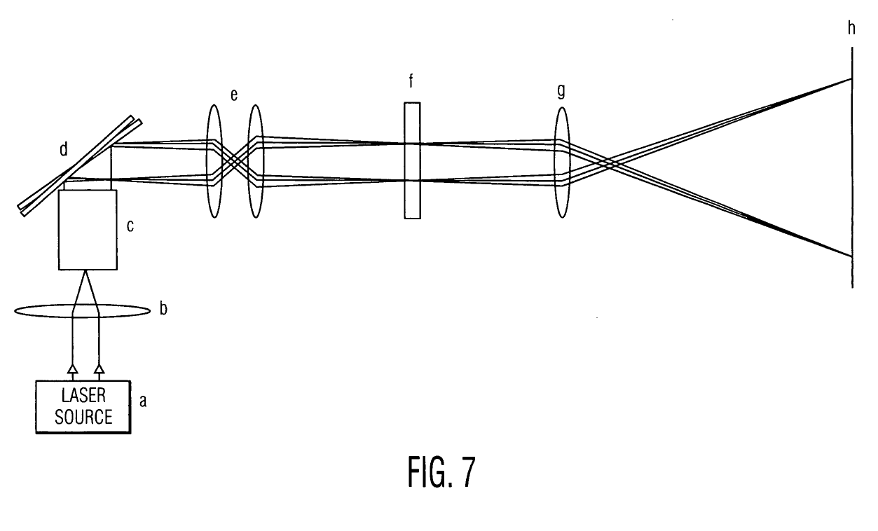

FIG. 7 illustrates a second preferred embodiment of a setup comprising a coupling lens 702 coupling collimated laser radiation to a multimode wave-guide 703, an oscillating mirror 704 scanning a widened and homogeneous laser beam leaving the wave-guide to a relay optics 705 first lens surface, the relay optics 705 minimizing aberrational effects and imaging single scanned rays onto a 2D light modulator panel 706, a projection lens 707 positioned between the 2D light modulator panel and a screen 708, the projection lens 707 imaging the light modulator panel 706 onto a screen 708 such that an angular scanning is imprinted onto the image and de-speckles the image.

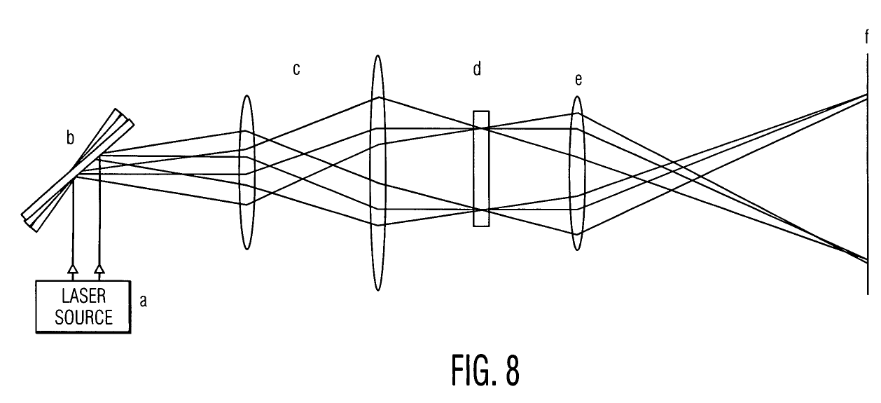

FIG. 8 illustrates a third preferred embodiment of a setup comprising an oscillating mirror 802 scanning a collimated laser beam to the surface of a lens (in this case a relay optics 803), a relay optics 803 imaging a mirror surface of the oscillating mirror 802 onto a 2D light modulation panel 804, a projection lens 805 placed between the 2D light modulation panel and a screen 806, the projection lens 805 imaging the light modulation panel 804 to the screen 806 such that an angular scanning is imprinted onto the image and de-speckles the image.

FIG. 1 illustrates light rays reflected by a structured surface. At layers 1, 2 and 3 intersecting light rays interfere and produce a speckle pattern, wherein, the speckle patterns vary for each layer;

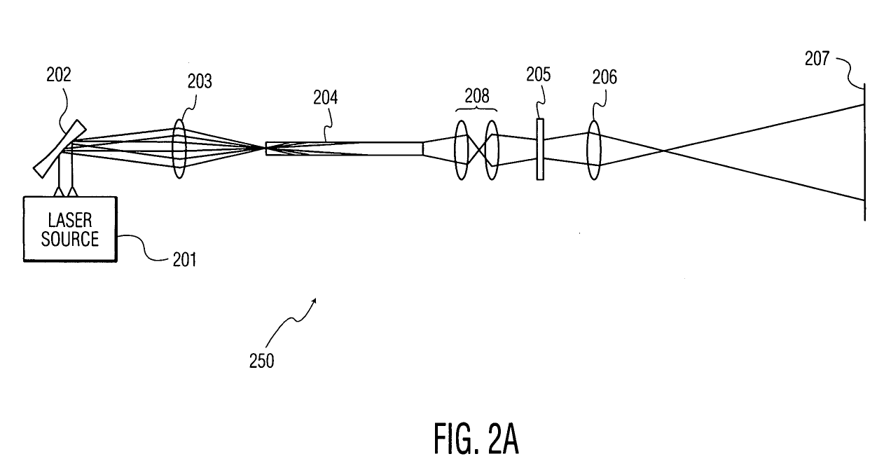

FIG. 2 illustrates a first preferred embodiment of a setup, according to the present invention;

FIG. 2A illustrates an alternative first preferred embodiment using telecentric illumination to image an end facet of the light guide of FIG. 2 onto the display panel;

FIG. 3 illustrates coupling a beam to a wave-guide such that separate rays scan the wave-guide end facet;

FIG. 4 illustrates a lens wherein when the scanning angle of incidence of a ray and the lens changes, the refractive power of the lens changes and one stable image plane is produced;

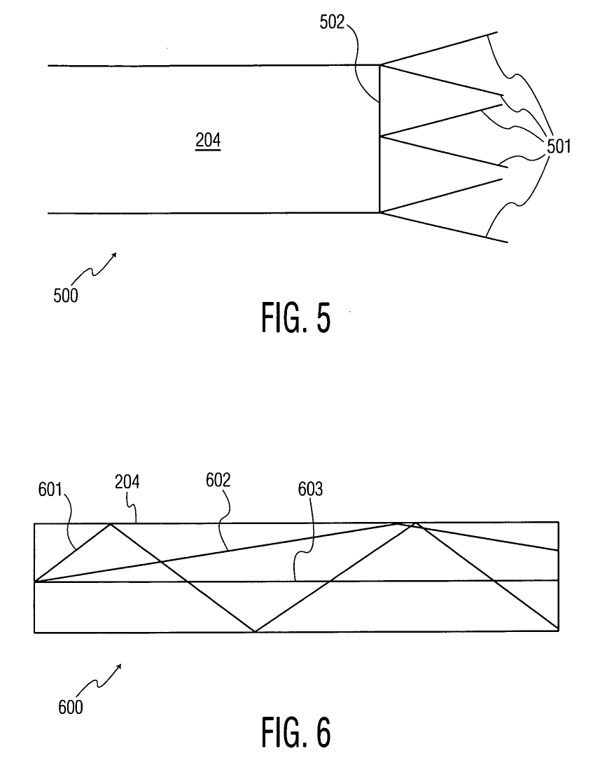

FIG. 5 illustrates light rays leaving a wave guide are scanning angularly;

FIG. 6 illustrates propagation of several transmissive modes in a multimode wave-guide;

FIG. 7 illustrates a second preferred embodiment of a setup, according to the present invention; and

FIG. 8 illustrates a preferred embodiment of a setup, according to the present invention.

The present invention provides a system, apparatus and method for a setup that reduces the visibility of speckle for laser imaging systems by making use of the rather long integration time of the human eye.

A first preferred embodiment of a setup 200 is illustrated in FIG. 2. The preferred setup comprises a collimated laser light source (e.g. a laser diode or DPSS laser) 201 to produce a collimated laser light beam, an oscillating mirror 202, a lens 203, a multimode wave-guide (e.g. a polymer optical fiber (POF) or a rectangularly/circularly shaped wave-guide) 204; a 1 or 2 dimensional light modulation panel (e.g., a 2D LCD Panel or a foil bar modulator 205), and a projection lens 206. The oscillating mirror is scanning the collimated laser light beam onto a surface of the lens 203. FIG. 2A illustrates an alternative embodiment of the setup of FIG. 2 in which telecentric illumination (e.g., relay optics 208) is used to image and end facet of the light guide 204 onto the display panel 205. The lens 203 images a surface of the oscillating mirror 202 in an image plane, wherein the image of the mirror is not moving, i.e., is stationary, see FIG. 4. An entrance facet of the multimode wave-guide 204 is placed in the stationary image plane and the collimated laser light beam (scanned by the oscillating mirror 202 and imaged by the lens 203 as a stationary image in an image plane) is coupled to a range of transmissive wave-guide modes of the multimode wave-guide 204, as illustrated in FIG. 3.

As the angle of incidence and the position at which the laser beam is hitting the lens 203 changes over time, the angle at which the light beam is coupled to the wave-guide 204 changes with a frequency equal to that of the oscillating mirror 202. Hence, the transmissive mode that the light beam is coupled to changes over time and a ray path of the light beam is folded due to multiple internal reflections thereof. Single rays of the light beam are scanning a waveguide end facet 502 such that the wave-guide end facet 502 is considered to be a second light source comprising an infinite number of small cone light sources 501 that are angularly scanning the wave-guide end facet 502, see FIG. 5. That is, the light beam is imprinted with angular scanning.

Additionally, a light beam homogenization is achieved at the same time.

After exiting the wave-guide 204, the light beam passes through the light modulation panel 205 and is imaged onto a screen 207 by the projection lens 206 such that the light beam retains its imprinted angular scanning. When being imaged by the projection lens 206, the angle at which the single light rays are hitting the screen 207 is changing (scanning angularly) and a resulting speckle pattern is changing. A sinusoidal oscillation of the mirror at high frequencies leads to a fast modulation of the resulting speckle pattern, which is integrated by the human eye. This produces a large reduction in a perception of resulting laser speckle by an observer.

Another effect reducing the speckle contrast is the so-called mode scrambling that appears in the multimode wave-guide 204, see FIG. 6. When light is coupled to the multimode wave-guide 204, several transmissive modes are excited. The fastest mode 603 transits straightforward and transmits the highest power because of low losses and damping. The slowest mode 601, that still fulfills the conditions of total internal reflection, has to travel a very long path compared to the foregoing mode. Because of the multiple reflections and the higher damping, this slowest mode 601 transports less optical power. Between these two extreme cases, a large number of transmissive modes are excited 602. The number of excited modes 601-603 depends on the composition of the wave-guide 204, e.g., on the refractive indices of the substrate and the surrounding matter and the dimensions of the wave-guide. The different travel times for the slowest 601 and the fastest mode 603 can be readily calculated. A resulting time difference is correlated with a path difference, which leads to a reduced coherence length of an imaged beam. Hence, the excitation of multiple transmissive modes 601-603 leads to a further reduction of the speckle contrast by perturbing the spatial coherence of the radiation.

A second preferred embodiment of a setup is illustrated in FIG. 7. The collimated laser beam is coupled to a multimode wave-guide 703 by an optional first lens 702. The oscillating mirror 704 is scanning the homogenized and widened laser beam exiting the wave-guide 703 onto the surface of a second lens 705 (in this example case relay optics are employed in order to reduce aberrations and obtain telecentric illumination, 705), which images the mirror surface onto a light modulation panel 706. The projection lens 707 images the light modulation panel 706 onto a screen 708. The imaged rays retain their imprinted angular scanning and the speckle contrast is reduced as described above.

One disadvantage of the second embodiment setup is that larger optics are needed to image the resulting widened laser beam. In addition, the scanning mirror cannot be in close proximity to the laser source 701. Hence, the imaged intensity pattern on the mirror 704 is somewhat enlarged and has trailing edges.

Another way to use angular scanning for the reduction of speckle is a third preferred embodiment of a setup, illustrated in FIG. 8. In this third embodiment, an oscillating mirror 802 is scanning a laser beam from a collimated laser source 801 onto a lens surface 803 (in this case a relay optics 803 in order to reduce aberrations, obtain telecentric illumination and widen the beam). The lens 803 images the scanning laser beam onto a light modulation panel 804, which is placed in a stationary image plane. A projection lens 805 images the laterally scanning beam to a stable image plane at a screen 806 in which the beam is not scanning laterally, but angularly. The speckle reduction is achieved as described above.

In the first and second embodiments, the wave-guide can be removed in a similar way to achieve further alternative embodiments.

The light modulator panel used in the above-described setups is preferably a 1D or 2D light modulation panel (e.g. LCD Panel). The multimode wave-guide used is preferably selected from the group consisting of a rectangularly-shaped waveguide, a circularly-shaped waveguide, and a Polymer optical fiber (POF). It should be noted that the first embodiment can give suboptimal picture performance, since the light panel is imaged, which is not necessarily the pivoting point of the angular scanning. A pivoting point is the end facet of the wave-guide. In order to have perfect picture performance, a lens doublet may be placed in between the end facet of the wave-guide and light panel. In this way the end facet of the wave-guide is imaged onto the light panel and both are pivoting points of the angular scanning.

All embodiments of setups presented above can be used with or without guiding structures to achieve alternative embodiments thereof. When a wave-guide is used, minimizations of the setup and beam homogenization are achieved in one step. Additionally, the setups that are not using a wave-guide have a smaller critical depth of focus. Although being a disadvantage for a mobile projector, these latter embodiments without wave-guides can be used to produce highly sensitive auto focus systems.

Although a collimated laser source was used in the above examples of preferred embodiment of setups, a divergent light source can be used as well.

A number of embodiments of setups are provided above to realize the above-described laser speckle reduction technique, the second embodiment being the most preferred, but it will be understood by those skilled in the art that these embodiments of setups of the present invention as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the claims appended hereto as well as all implementation techniques.

1. A display setup (700) for displaying a two dimensional image on a surface (708) comprising:
a multimode wave-guide (703) that receives as input a laser beam from a laser source (701) and outputs a homogenized and widened laser beam;
an oscillating mirror (704) that scans the homogenized and widened laser beam, thereby angularly scanning the laser beam;
a light modulation panel (706) having a surface to receive an image of the surface of the mirror having said angular scanning imprinted thereon, said panel (706) to modulate an intensity per pixel of said image of the surface of the mirror;
a second lens (705) onto which the oscillating mirror (704) scans the image of the surface of the mirror, said second lens (705) to image the surface of the mirror onto the surface of the light modulation panel (706) such that the image of the surface of the mirror is stable at said light modulation panel (706); and
a projection lens (707) that projects onto the surface (708) the surface of the light panel (706) such that the projected surface of the light panel and the lens retain the angular scanning imprinted thereon,
wherein a visibility of a laser speckle in the projected images is reduced.

2. The display setup (700) of claim 1, further comprising a first lens (702) that couples the laser beam from the laser source (701) to an input facet of the multimode wave-guide (703).

3. (canceled)

4. The display setup (700) of claim 1, wherein the second lens is a relay optics (705) that reduces aberrations and provides telecentric illumination.

5. The display setup (700) of claim 4, wherein said multimode waveguide (703) accepts multiple transmissive modes (601)-(603) thereby perturbing a spatial coherence of the light beam and reducing a contrast of the laser speckle.

6. (canceled)

7. The display setup (700) of claim 4, wherein said light modulation panel (706) is one of a 1D light modulation panel plus additional scanning mirror and a 2D light modulation panel.

8-9. (canceled)

10. The display setup (700) of claim 9, wherein said multimode waveguide (703) accepts multiple transmissive modes (601)-(603) thereby perturbing a spatial coherence of the light beam and reducing a contrast of the laser speckle.

11. The display setup (700) of claim 10, wherein the second lens is a relay optics (705) that reduces aberrations and provides telecentric illumination.

12. A display setup (200) for displaying a two dimensional image on a surface (207), comprising:
a lens (203) that images a laser beam as a stationary image in an image plane;
an oscillating mirror (202) that scans the laser beam as image of a surface thereof onto a surface of the lens (203);
a multimode wave-guide (204) having an entrance facet thereof placed in said image plane to couple therewith and output a homogenized light beam having an angular scanning imprinted thereon; and
a light modulation panel (205) that modulates an intensity per pixel, and
a projection lens (206) that images the light panel onto the screen (207) such that the light beam retains the angular scanning imprinted thereon,
wherein a visibility of a laser speckle in the projected images is reduced.

13. (canceled)

14. The display setup (200) of claim 12, further comprising a relay optics (208) between an end facet of the multimode wave-guide (204) and the light modulation panel (205) that reduces aberrations and provides telecentric illumination.

15. The display setup (200) of claim 12, wherein said multimode wave-guide accepts multiple transmissive modes (601)-(603) thereby perturbing a spatial coherence of the light beam and reducing a contrast of the laser speckle.

16. (canceled)

17. The display setup (200) of claim 12, wherein said light modulation panel is one of a 1D light modulation panel plus additional scanning mirror and a 2D light modulation panel.

18-19. (canceled)

20. The display setup (200) of claim 19, wherein said multimode wave-guide excites multiple transmissive modes (601)-(603) thereby perturbing a spatial coherence of the light beam and reducing a contrast of the laser speckle.

21-26. (canceled)

27. A method for displaying a two dimensional image on a display screen (806), comprising:
scanning a laser beam onto a lens (803) using an oscillating mirror (802) as an image of a surface of the mirror to thereby imprint angular scanning thereon;
imaging onto a light modulation panel (804) by said lens (803) the image of the surface of the mirror having angular scanning imprinted thereon;
the light modulation panel (804) modulating an intensity per pixel; and
projecting onto the screen (806) the surface of the light modulation panel (804) such that the modulated laser beam retains the angular scanning imprinted thereon and the projected image is stable,
wherein, a visibility of laser speckle in the projected image is reduced.

28. (canceled)

29. The method of claim 27, wherein the lens (803) is a relay optics that reduces aberrations and provides telecentric illumination.

30. The method of claim 29, wherein said light modulation panel (804) is one of a 1D light modulation panel plus additional scanning mirror and a 2D light modulation panel.

31. (canceled)
